(19) United States
(12) Patent Application Publication
(10) Pub. No.: US 2009/0202870 A1
(43) Pub. Date: Aug. 13, 2009

(54) Fuel Cell Employing Hydrated Non-Perfluorinated Hydrocarbon Ion Exchange Membrane

(76) Inventors: Robert M. Darling, South Windsor, CT (US); Shruti Modi Gupta, Windsor, CT (US)

Correspondence Address: M P Williams, 210 Main Street, Manchester, CT, 06042, US

(21) Appl. No.: 12/226,930

(22) PCT Filed: May 30, 2006
(86) PCT No.: PCT/US2006/020982

§ 371 Date: Jan. 23, 2009

(51) Int. Cl. H01M 8/04; H01M 8/10

(52) U.S. Cl. 429/13; 429/33

(57) ABSTRACT

Fuel cells (9) include unitized electrode assemblies (12) having a non-perfluorinated hydrocarbon ionomer exchange membrane (26) with anode and cathode catalysts (27, 28) disposed on opposite sides thereof. Adjacent the catalysts, respective optional sublayers (29, 30) may be supported by corresponding gas diffusion layers (31, 32), with adjacent porous, hydrophilic, water transferring reactant gas flow field plates (13, 14) having respective fuel (17) and oxidant (23) reactant gas flow field channels. Water channels (18, 19, 20)hydrate the membrane (26), clear the product water from the cathode (28, 30, 32), flush peroxide radicals, and may also cool the fuel cells. Improved performance (124) (higher voltage at higher current densities) is achieved along with elimination of a propensity for degradation from peroxide decomposition products resulting from oxygen solubility of perfluorinated membranes. Platinum/ruthenium alloy anode catalysts improve performance without degradation which occurs with perfluorinated membranes.

### TECHNICAL FIELD

This invention relates to utilization in fuel cells of non-perfluorinated hydrocarbon ion exchange membranes which are rendered substantially 100% hydrated by means of one or more porous, hydrophilic, water transferring reactant gas flow field plates that assure hydration while avoiding flooding, and to platinum and platinum alloy fuel cell catalyst combined therewith.

### BACKGROUND ART

Fuel cells which have drawn attention, because of being compact and capable of providing high current densities, are the solid polymer electrolyte fuel cells. These are frequently referred to as “proton exchange membrane” (PEM) fuel cells as well. The ion exchange membrane, which is a solid polymer electrolyte, most typically comprises a perfluorinated hydrocarbon ionomer, such as that sold under the trademark NAFION®, by DuPont.

However, these membranes are expensive and are prone to degradation due to peroxide formation and its subsequent decomposition products resulting from oxygen solubility. In addition, these membranes allow some H₂ to cross over to the cathode, which has a negative effect on fuel cell efficiency. This is especially important at low reactant flow rates used during low power operation (as is frequently seen in vehicle applications), because the H₂ crossover rate does not change with fuel flow rates and therefore becomes a larger percentage of fuel consumption.

PEM fuel cell stacks may be fueled with hydrogen-rich reformate gas (syngas) which includes on the order of 10 ppm to 100 ppm of carbon monoxide. Some of the CO attaches to the platinum of the anode catalyst which inhibits the ability of the platinum catalyst sites to oxidize hydrogen which in turn reduces fuel cell performance. The use of a platinum/ruthenium alloy as an anode catalyst improves tolerance to carbon monoxide at typical PEM fuel cell operating temperatures. However, the improved performance is short-lived because the ruthenium in the anode is unstable and tends to migrate through the membrane until it is deposited on the cathode. Ruthenium on the cathode inhibits the cathode reaction, resulting in reduced fuel cell performance.

### DISCLOSURE OF INVENTION

Aspects of the invention include: lower cost proton exchange membranes for fuel cells; proton exchange membranes for fuel cells with improved durability and improved tolerance to carbon monoxide; and low cost, highly durable proton exchange membranes for fuel cells which does not require expensive power plant components that are difficult to control.

This invention is predicated in part on the realization that fuel cell electrolytes including inexpensive and durable non-perfluorinated hydrocarbon ionomer membranes have been unsatisfactory due to poor proton conductivity when not fully hydrated, and the hydration thereof by external humidification of reactant gases requires additional water volume and expensive additional equipment which is difficult to control. The invention is also predicated on the discovery that non-perfluorinated hydrocarbon ionomer membranes provide better fuel cell performance when hydrated with liquid phase water than when hydrated with gas phase water. The invention is predicated in part on the realization that normal hydration methods for supplying water for membrane humidification through the inlet reactant gas streams require complex gas humidification and water management systems that are expensive and difficult to control.

The invention recognizes that the concentration of peroxide radicals that form in fuel cells and attack non-perfluorinated membranes can be reduced by water in porous, hydrophilic reactant gas flow field plates, as the water flows through the coolant channels to a water outlet.

The invention is predicated also on the recognition of the fact that non-perfluorinated hydrocarbon ionomer membranes may have less ruthenium solubility than per-fluorinated hydrocarbon ionomer membranes, and can operate much longer than per-fluorinated membranes without loss of performance, thereby benefiting from improved performance of platinum/ruthenium alloy anode catalysts.

In accordance with the invention, non-perfluorinated hydrocarbon ionomer membranes used as fuel cell electrolytes are hydrated with liquid phase water.

According to the present invention, fuel cells employ non-perfluorinated hydrocarbon ionomer membranes in combination with one or more porous, hydrophilic water transferring reactant gas flow field plates which are designed to assure adequate humidification of the membrane without flooding of the electrodes on either side of the membrane, and without external humidification of incoming reactant gases.

In accordance with the invention, a non-perfluorinated hydrocarbon ionomer membrane may be sandwiched between a hydrophilic anode gas diffusion layer, optionally with a thin sublayer, and a similar cathode gas diffusion layer.

The invention achieves a durable fuel cell package that includes a hydrocarbon membrane in combination with a water transferring reactant gas flow field plate.

The invention results in adequate performance (proton conductivity) of a non-perfluorinated hydrocarbon ionomer membrane without the necessity of externally humidifying reactants, and the concomitant necessity to utilize expensive power plant components which are difficult to maintain in proper operational balance.

Hydrocarbon membranes swell and contract to a greater extent than non-perfluorinated ionomer membranes as a result of hydration variations, which in turn may cause failures resulting from mechanical stresses. The improved humidity control of the porous hydrophilic water transferring reactant gas flow field plates and porous gas diffusion layers assures a more complete and stable hydration of the entire hydrocarbon membrane, which increases dimensional stability and reduces mechanical stresses.

The invention applies the benefit of low reactant solubility to enhance the durability of humidified, non-perfluorinated hydrocarbon ionomer membranes in fuel cells to achieve a durable, low cost PEM fuel cell. The invention also improves fuel cell efficiency, especially at low power operation, by reducing the H₂ crossover rate.

In accordance with the invention, non-perfluorinated hydrocarbon ionomer membranes in PEM fuel cells allow use of platinum/ruthenium alloy catalysts with better performance than platinum alone, with no reduction of durability.

Other aspects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a side elevation cross sectional view of fuel cells employing the present invention, with sectional lines omitted for clarity.

FIG. 2 is a fractional, exploded view of the fuel cells of FIG. 1, with further detail.

FIG. 3 is a graph comparing performance of (a) a fuel cell having a non-perfluorinated hydrocarbon ionomer membrane and solid reactant flow plates consuming externally humidified reactants with (b) a fuel cell having a non-perfluorinated hydrocarbon ionomer membrane and liquid water transferring components in accordance with the present invention.

### MODE(S) FOR CARRYING OUT THE INVENTION

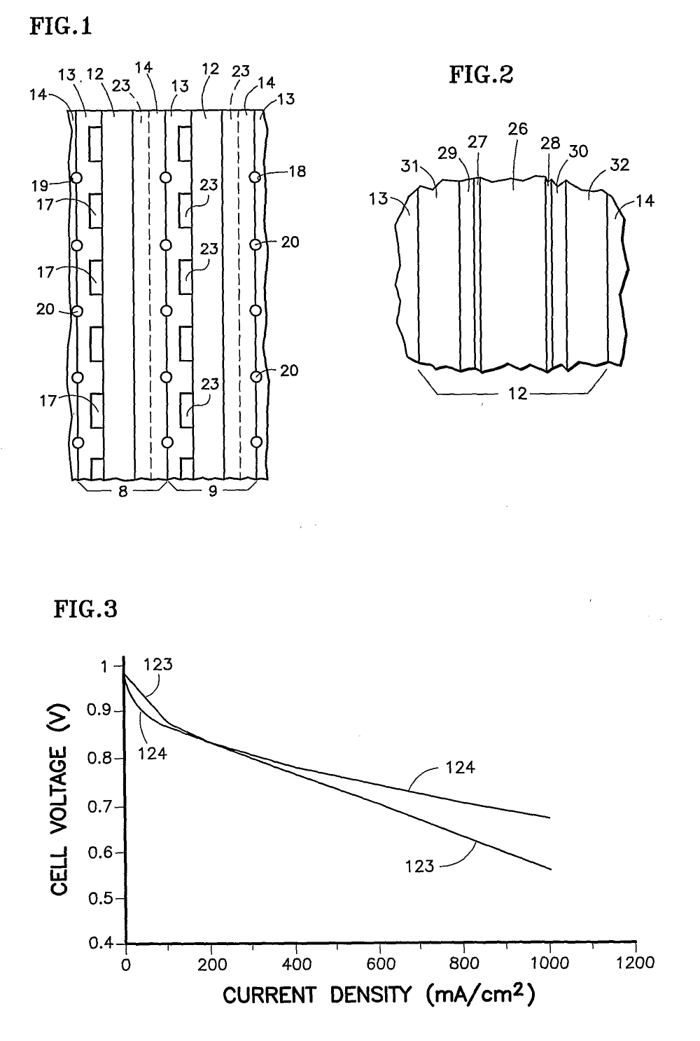

Referring to FIG. 1, portions of a pair of fuel cells 8, 9 are illustrated. Each fuel cell has a unitized electrode assembly 12, a porous, hydrophilic fuel reactant gas flow field plate 13 and a porous, hydrophilic oxidant reactant gas flow field plate 14. The fuel reactant gas flow field plates 13 includes fuel flow channels 17 and grooves 18 which, with grooves 19 in the oxidant reactant gas flow field plates 14, form channels 20 for liquid water that hydrates the membrane and for removal of product water from the cathodes. The oxidant reactant gas flow field plates 14 have oxidant reactant gas flow field channels 23.

The channels 20 may be of large cross-section, sufficient to carry enough water for convectively cooling the fuel cells by transfer of sensible heat to the water. This may be achieved with a coolant pump, heat exchanger and controls, or this may be achieved in a passive system, having no water pump and relying on convective or other passive water circulation. On the other hand, the channels may be of a small cross section, carrying just enough water for hydration of the membrane in a fuel cell stack having separate cooler plates interspersed with the fuel cells, typically using a freeze-point depressing mixture, such as glycol. The small channels may be used in an evaporatively cooled system, carrying just enough water to prevent cathode flooding, provide hydration of the membrane and to replace evaporated water. The invention may be used in all the aforementioned types of systems.

Referring to FIG. 2, the unitized electrode assemblies 12 each comprise a non-perfluorinated hydrocarbon ionomer membrane 26 having anode catalysts 27 and cathode catalysts 28 thereon, sandwiched between a pair of sublayers 29, 30, each of which is supported by a corresponding gas diffusion layer 31, 32. The membrane 26 is not perfluorinated, and is therefore less expensive, potentially more durable, and supports the use of various platinum and platinum alloys as anode catalysts.

According to the invention, liquid water flowing in the channels 20 will hydrate the membrane through both the anode reactant gas flow field plate 13 and the cathode reactant gas flow field plate 14. The porosity of the flow field plates 13, 14, the pore size, and the pressure differential established between the reactant gases and the water in the channels 20 can all be selected to assure that both the reactant gases and the water reach the membrane 26 within the unitized electrode assembly 12. Flow of liquid water through the gas diffusion layers 31, 32 and bilayers 29, 30 can be controlled in a manner described in patent publication US2004-0106034; pressure differentials between coolant and water are described therein and in U.S. Pat. No. 5,700,595.

Referring to FIG. 3, the performance 123 of a fuel cell employing a non-perfluorinated hydrocarbon ionomer membrane and solid reactant gas flow field plates is plotted. During the operation that resulted in the performance plot 123, the reactants, which were substantially pure hydrogen and air, were externally saturated with water at 65° C, the relative humidity being 100%. It can be seen that the voltage droops to about 0.56 volts at a current density of 1,000 milliamps per square centimeter. On the other hand, operation of a fuel cell employing the non-perfluorinated hydrocarbon ionomer membrane with porous, hydrophilic, water transferring reactant gas flow field plates 13, 14 and porous gas diffusion layers 31, 32 in accordance with the present invention, that resulted in the performance plot 124, was with non-humidified reactant gases at 65° C. It is clear that voltage of the fuel cell employing the invention remained above about 0.67 volts.

The performance plots 123, 124 were both achieved with platinum anode catalysts.

The sublayers 29, 30, particularly the anode sublayers 29, may be made to be wettable (hydrophilic), or partially wettable, to allow water to pass therethrough to hydrate the anode side of the non-perfluorinated membrane 26. Or the bilayers may be partially hydrophobic or hydrophilic (non-wettable) and rely on vapor phase transmission of moisture to the membrane. However, in such case, the water is nonetheless supplied to each fuel cell in the liquid phase through the porous, hydrophilic water transferring reactant gas flow field plates. Adjusting the wettability of the bilayers may be accomplished in a variety of ways known to the prior art; one way is described in said patent publication at paragraphs 0053 and 0055 (referred to therein as “diffusion layers”). If desired, the sublayer 29 may be omitted from the anode side, and if desired, the sublayer 30 may be omitted from the cathode side.

If desired, the invention may be practiced with one solid reactant gas flow field plate, preferably on the cathode side, and one porous, hydrophilic water transferring reactant gas flow field plate, preferably on the anode side.

A conventional deionizer (sometimes called “demineralizer”) may be used to remove peroxide radicals from the coolant water.

1. A fuel cell (8, 9) characterized by:
a non-perfluorinated hydrocarbon ionomer membrane electrolyte (26) having anode catalyst (27) and cathode catalyst (28) disposed on opposing surfaces of said membrane electrolyte, with a porous, gas diffusion layer (31, 32) disposed near each of said catalysts;
a first porous, hydrophilic, water transferring reactant gas flow field plate (13, 14) adjacent to one of said gas diffusion layers (31, 32); and
a second reactant gas flow field plate (14, 13) adjacent to the other one of said gas diffusion layers (32, 31).

2. A fuel cell (89) according to claim 1, further characterized by:
said gas diffusion layer (31, 32) being hydrophilic.

3. A fuel cell (8, 9) according to claim 1 further characterized by:
a sublayer (29, 30) between at least one of said catalysts (27, 28) and a corresponding one of said flow field plates (13, 14).

4. A fuel cell (8, 9) according to claim 1 further characterized by:
said second reactant gas flow field plate (14, 13) being a porous, hydrophilic, water transferring reactant gas flow field plate.

5. A fuel cell (8, 9) according to claim 1 further characterized by:
said second reactant gas flow field plate (14, 13) being a solid reactant gas flow field plate.

6. A fuel cell (8, 9) according to claim 1 further characterized by:
at least one of said catalysts (27, 28) comprising a platinum alloy.

7. A fuel cell (8, 9) according to claim 1 further characterized by:
at least one of said catalysts (27, 28) comprising a platinum/ruthenium alloy.

8. A fuel cell (8, 9) according to claim 1 further characterized by:
said anode catalyst (27) comprising a platinum/ruthenium alloy.

9. A fuel cell membrane electrolyte (26) characterized by said membrane electrolyte comprising a non-perfluorinated hydrocarbon ionomer membrane electrolyte (26) completely hydrated with water provided (13, 14, 20, 31, 32) to said membrane electrolyte in the liquid phase.

10. A method of operating a fuel cell (8, 9) having a non-perfluorinated hydrocarbon ionomer membrane electrolyte (26) characterized by:
completely hydrating (13, 14, 31, 32) said membrane electrolyte (26) with water provided (20) to said fuel cell in the liquid phase.

11. A method according to claim 10 further characterized by:
completely hydrating (13, 14, 31, 32) said membrane electrolyte (26) with water provided (13, 14, 20, 31, 32) to said membrane electrolyte in the liquid phase.

12. A fuel cell (8, 9) comprising:
a non-perfluorinated hydrocarbon ionomer membrane electrolyte (26);
characterized by:
means (13, 14, 31, 32) for completely hydrating said membrane electrolyte with water provided (20) to said fuel cell in the liquid phase.

13. A fuel cell (8, 9) according to claim 12 further characterized by:
means (13, 14, 31, 32) for completely hydrating said membrane electrolyte with water provided (13, 14, 20, 31, 32) to said membrane electrolyte (26) in the liquid phase.
